(19) United States
(12) Patent Application Publication
(10) Pub. No.: US 2010/0079782 A1
(43) Pub. Date: Apr. 1, 2010

(54) INFORMATION PROCESSING DEVICE AND COMPUTER READABLE STORAGE MEDIUM USED THEREIN

(75) Inventors: Seiji TSUYA, Nagoya-shi (JP); Norihiko ASAI, Tajimi-shi (JP)

Correspondence Address: Scully, Scott, Murphy &Presser, P.C., 400 Garden City Plaze, Suite 300, Garden City, NY, 11530, US

(73) Assignee: BROTHER KOGYO KABUSHIKI KAISHA, Aichi-ken (JP)

(21) Appl. No.: 12/568,177

(22) Filed: Sep. 28, 2009

(30) Foreign Application Priority Data
Sep. 29, 2008 (JP) 2008-251863

(51) Int. Cl. G06F 3/12

(52) U.S. Cl. 358/1.13

(57) ABSTRACT

A computer readable storage medium storing a computer-executable installation program is for installing, on an information processing, device which is connectable with a peripheral device in a plurality of connection modes, software including at least one device driver for the peripheral device upon setting installation mode to each connection mode. The installation program includes first detecting the peripheral device connected with the information processing device, second detecting the connection mode of the detected peripheral device, determining whether or not at least one device driver for the detected peripheral device has been installed on the information processing device in accordance with the detected connection mode, and automatically setting the installation mode to the detected connection mode to install the device driver in accordance with the detected connection mode if at least one device driver has not been installed on the information processing device in accordance with the detected connection mode.

### CROSS REFERENCE TO RELATED APPLICATION

This application claims priority from Japanese Patent Application No. 2008-251863 filed Sep. 29, 2008. The entire content of this priority application is incorporated herein by reference.

### TECHNICAL FIELD

The present invention relates to an installation device and computer readable storage medium used therein.

### BACKGROUND

Conventionally, an installation program (hereinafter referred to as “installer”) for installing, in a personal computer (hereinafter referred to as “PC”), a device driver for a peripheral device network-connected or locally connected to the PC has been well known. The peripheral device includes, for example, a copier, a printer, a facsimile machine, a scanner and a multifunctional peripheral (hereinafter referred to as “MFP”).

When installing a device driver, an installer displays the Peripheral devices network-connected and locally connected to the PC, and prompts the user to select one or more peripheral devices from the displayed peripheral devices. If the device driver for the selected peripheral device has not been installed, the installer installs the device driver. On the other hand, if the device driver for the selected peripheral device has been installed, the installer compares the version of the device driver to be installed with the version of the driver that has been already installed and displays the comparison result.

### SUMMARY

However, the installer generally needs to install a device driver in accordance with the connecting mode of the selected peripheral to the PC 1. In other words, if one peripheral device and another peripheral device both having a same model are connected to the PC in a different connecting mode, it is required to install a device driver for one peripheral device and a device driver another peripheral device separately. In such case, a user needs to find out a desired peripheral device for which a device driver should be installed from a plurality of peripheral devices connected to the PC.

Further, if the peripheral is an MFP, not only a device driver but also an application software for a desired function of the MFP needs to be installed. For this reason, even if a device driver for a peripheral device has been installed, there is also a necessity to install an application software for a new desired function with an input by a user. In such case, a user also needs to find out a desired peripheral device for which an application software should be installed from a plurality of peripheral devices connected to the PC.

In view of the foregoing, it is an object of the invention to provide an installation device and computer readable storage medium used therein capable of easily and simply installing a device driver and an application software for a peripheral device. In order to attain the above and other objects, the invention provides a computer readable storage medium storing a computer-executable installation program for installing, on an information processing device which is connectable with a peripheral device in a plurality of connection modes, a software including at least one device driver for the peripheral device upon setting installation mode to each connection mode. The installation program includes instructions (a) for detecting the peripheral device connected with the information processing device, instructions (b) for detecting the connection mode of the detected peripheral device, instructions (c) for determining whether or not at least one device driver for the detected peripheral device has been installed on the information processing device in accordance with the detected connection mode; and instructions (d) for automatically setting the installation mode to the detected connection mode to install the device driver in accordance with the detected connection mode if at least one device driver for the detected peripheral device has not been installed on the information processing device in accordance with the detected connection mode.

According to another aspect, the present invention provides a computer readable storage medium storing a computer-executable installation program for installing, on an information processing device which is connectable with a peripheral device in a plurality of connection modes, a software including at least one device driver for the peripheral device upon setting installation mode to each connection mode. The installation program includes instructions (a) for detecting a plurality of peripheral devices connected with the information processing device, instructions (b) for detecting the connection mode of each peripheral device detected in instructions (a), instructions (c) for detecting the number of the peripheral device detected in instructions (a) for which at least one device driver has been installed on the information processing device in accordance with the detected connection mode, instructions (d) for automatically setting the installation mode to the detected connection mode to install the device driver in accordance with the detected connection mode, if the number detected in instructions (c) is one.

According to still another aspect, present invention provides a computer readable storage medium storing a computer-executable installation program for installing, on an information processing device which is connectable with a peripheral device in a plurality of connection modes, a software including at least one device driver for the peripheral device upon setting installation mode to each connection mode. The installation program includes instructions (a) for detecting the peripheral device connected with the information processing device, instructions (b) for detecting the connection mode of the detected peripheral device, instructions (c) for determining whether or not all of the device drivers for the detected peripheral device have been installed on the information processing device in accordance with a predetermined connection mode, and instructions (d) for automatically setting the installation mode to a connection mode different from the detected connection mode to install the device driver in accordance with the detected connection mode if all of the device drivers for the detected peripheral device have been installed on the information processing device in accordance with the predetermined connection mode.

According to still another aspect, the present invention provides an information processing device. The information processing device is connectable with a peripheral device in a plurality of connection modes. The information processing device is for installing a software including at least one device driver for the peripheral device thereon upon setting installation mode to each connection mode. The information processing device includes a first detecting unit, a second detecting unit, a determining unit, and setting unit. The first detecting unit detects the peripheral device connected with the information processing device. The second detecting unit detects the connection mode of the detected peripheral device. The determining unit determines whether or not at least one device driver for the detected peripheral device has been installed on the information processing device in accordance with the detected connection mode. The setting unit automatically sets the installation mode to the detected connection mode to install the device driver in accordance with the detected connection mode if at least one device driver for the detected peripheral device has not been installed on the information processing device in accordance with the detected connection mode.

According to still another aspect, the present invention provides an information processing device. The information processing device is connectable with a peripheral device in a plurality of connection modes. The information processing device is for installing a software including at least one device driver for the peripheral device thereon upon setting installation mode to each connection mode. The installation device includes a first detecting unit, a second detecting unit, a third detecting unit, and a setting unit The fast detecting unit detects a plurality of peripheral devices connected with the information processing device. The second detecting unit detects the connection mode of each peripheral device detected in the first detecting unit. The third detecting unit detects the number of the peripheral device detected in the first detecting unit for which at least one device driver has been installed on the information processing device in accordance with the detected connection mode. The setting unit automatically sets the installation mode to the detected connection mode to install the device driver in accordance with the detected connection mode, if the number detected in the third detecting unit is one.

According to still another aspect, the present invention provides an information processing device. The information processing device connectable with a peripheral device in a plurality of connection modes. The information processing device is for installing a software including at least one device driver for the peripheral device thereon upon setting installation mode to each connection mode. The information processing device includes a first detecting unit, a second detecting unit, a determining unit, and a setting unit. The first detecting unit detects the peripheral device connected with the information processing device. The second detecting unit detects the connection mode of the detected peripheral device. The determining unit determines whether or not all of the device drivers for the detected peripheral device have been installed on the information processing device in accordance with a predetermined connection mode. The setting unit automatically sets the installation mode to a connection mode different from the detected connection mode to install the device driver in accordance with the detected connection mode if all of the device drivers for the detected peripheral device have been installed on the information processing device in accordance with the predetermined connection mode.

### BRIEF DESCRIPTION OF THE DRAWINGS

The particular features and advantages of the invention as well as other objects will become apparent from the following description taken in connection With the accompanying drawings, in which:

FIG. 1 is a block diagram showing a connection state between a PC and four MFPs;

FIG. 2 is a block diagram showing an electrical arrangement between the PC and the MFPs;

FIG. 3 is a table showing memory configuration of a memory for storing installation status for a target device;

FIG. 4 is a flowchart illustrating steps in an installation process by a CPU according to a first embodiment of the present invention;

FIG. 5 is a flowchart illustrating steps in a process for detecting a target device for which a device driver is to be installed;

FIG. 6(a) is a flowchart illustrating steps in a new installation process;

FIG. 6(b) is a flowchart illustrating steps in an additional installation process;

FIG. 6(c) is a flowchart illustrating steps in an individual installation

FIG. 7(a) is a conceptual diagram of a confirmation screen;

FIG. 7(b) is a conceptual diagram of a software selection screen;

FIG. 7(c) is a conceptual diagram of an installation device selection screen; and

FIG. 8 is a flowchart illustrating steps in an installation process according to a second embodiment of the present invention.

### DETAILED DESCRIPTION

An installation program and an installation device according to a first embodiment of the invention will be described while referring to the accompanying drawings.

A PC 10 is an installation device according to the present invention. An installation program serves as an installer which is executed by the PC 10. According to the present embodiment, MFPs 20, 30, 40 and 50 (peripheral devices) are connected to the PC 10, and the installer can install a software including device drivers slid application softwares for the MFPs 20, 30, 40 and 50 in the PC 10.

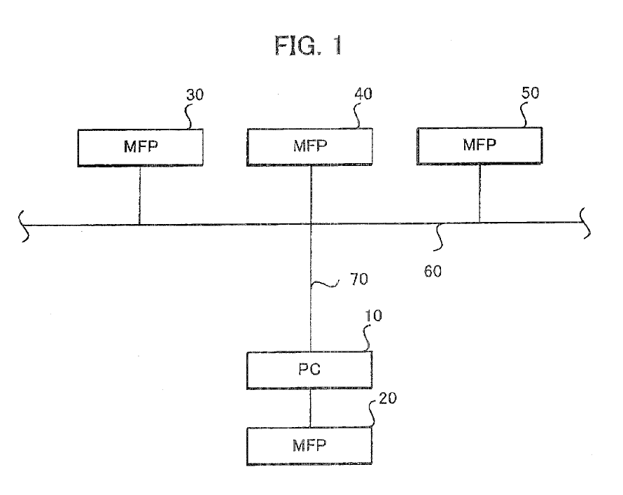

As shown in FIG. 1, the MFP 20 is locally connected to the PC 10 via a USB (universal serial bus) cable 70, while the MFPs 30, 40, and 50 are network-connected to the PC 10 via a LAN (local area network) cable 60.

The PC 10 in which the device drivers and the application softwares for the MFPs 20, 30, 40 and 50 are installed according to modes of connection with the PC 10 (a local connection or a network connection) is capable of controlling the MFPs 20, 30, 40, and 50.

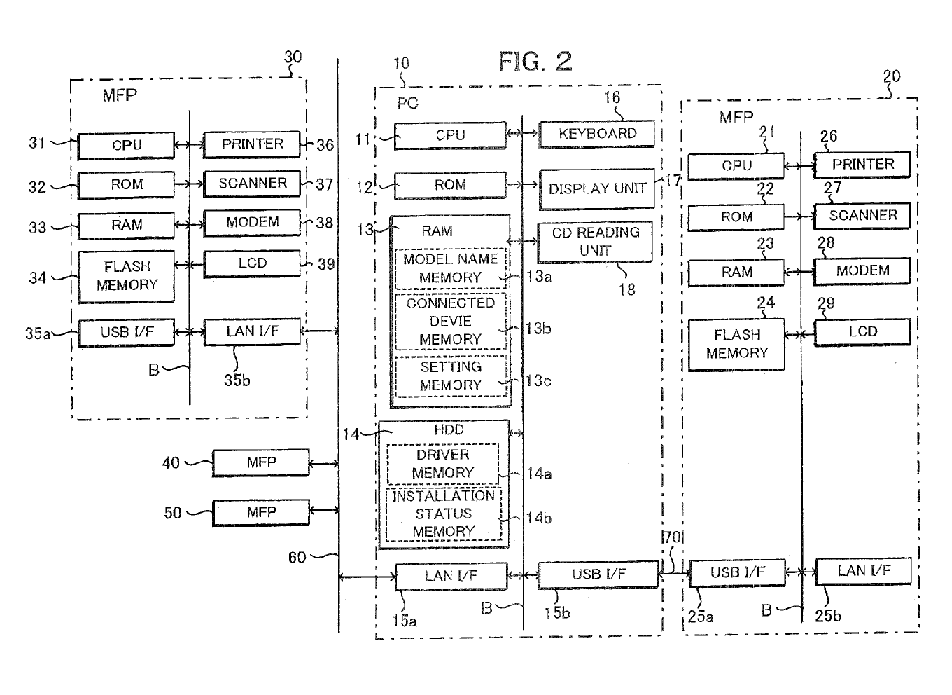

As shown in FIG. 2, the PC 10 primarily includes a CPU (central processing unit) 11, a ROM (read only memory) 12, a RAM (random access memory) 13, and a IUD (hard disk drive) 14. Further, the PC 10 includes a LAN interface (LAN I/F) 15a for connecting to the LAN cable 60, a USB interface (USB I/F) 15b, a keyboard 16, a display unit 17 for displaying characters and images thereon, a CD reading unit 18 for reading data stored in a CD. The CPU 11, the ROM 12, the RAM 13, the HDD 14, the LAN I/F 15a, the USB 15b, the keyboard 16, the display unit 17, and the CD reading unit 18 are interconnected through a bus line B.

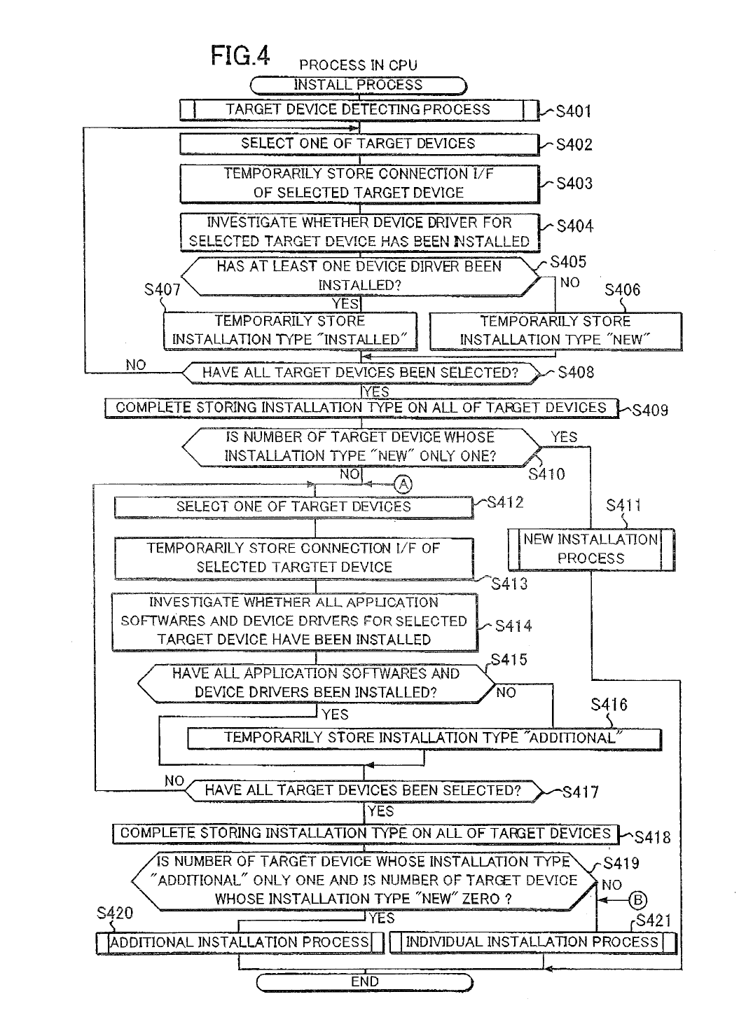

The CPU 11 is a central processing unit to control the PC 10 as a whole. In particular, the CPU 11 executes processes shown in the flowcharts of FIGS. 4 to 6, and 8 in accordance with the installer's instruction. Note that she installer is read out from the HDD 14, a CD-ROM or a website, and stored into the RAM 13. The ROM 12 is a nonvolatile memory in which a basic software called BIOS (basic input/output system) is stored.

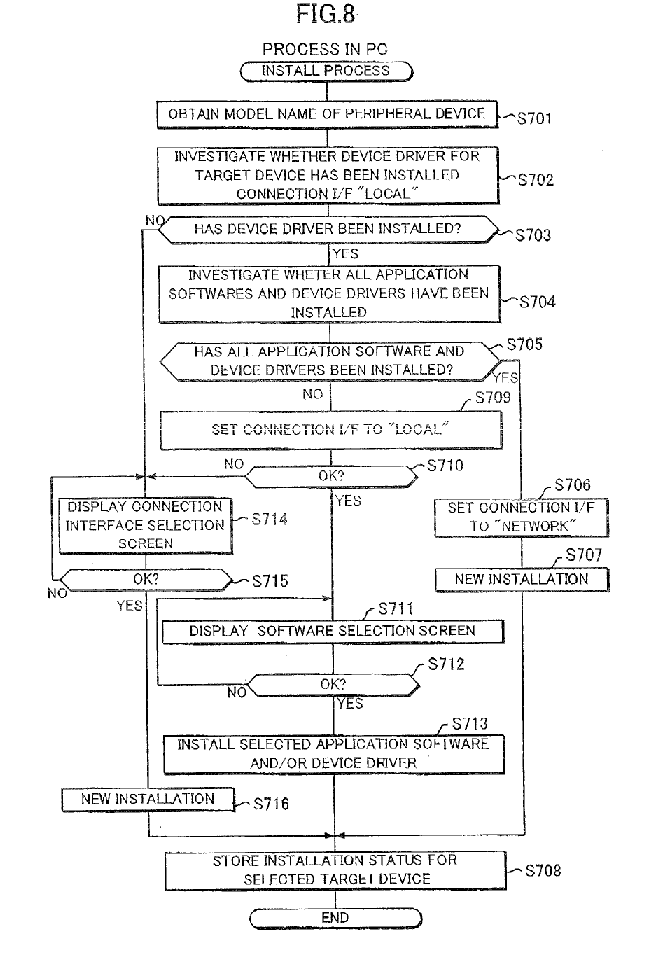

The RAM 13 is a volatile memory for temporarily storing data and programs necessary for several processes to be executed by the CPU 11. The RAM 13 includes a model name memory 13a, a connected device memory 13b, and a setting memory 13c that are used in installation processes shown in the flowcharts of FIGS. 4 and 8 for installing the device drivers and the application softwares.

The model name memory 13a is a storage area for storing a model name of a peripheral device for which the installer should install the device driver and the application software. The connected device memory 13b is a storage area for storing. IP addresses or port name of peripheral devices connected to the PC 10, whose model name are identical to the model name stored in the model name memory 13a. The setting memory 13c is a storage area for temporarily storing setting conditions set during the installation process shown in FIG. 4.

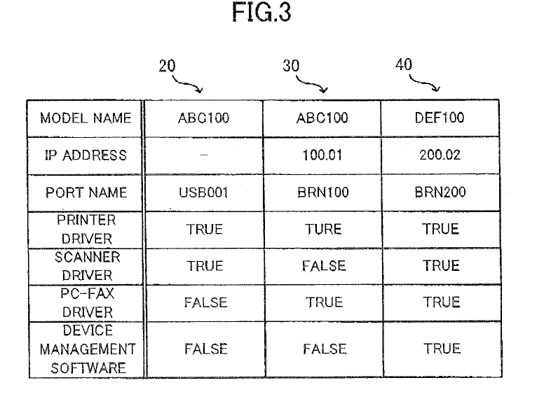

The HDD 14 includes a driver memory 14a and an installation status memory 14b, both of which are nonvolatile memories. The driver memory 14a is a storage area for storing device drivers and application software. The installation status memory 14b is a storage area for storing installation status of device drivers and application software for each peripheral device connected to the PC 10. Here, a structure of the installation status memory 14b will be described while referring to FIG. 3.

FIG. 3 is a table showing a structured of the installation status memory 14b. The installation status memory 14b stores data, such as the model name, the IP address, the port name, and the installation status of the device driver and the application software, for each peripheral device connected to the PC 10. In FIG. 3, a printer driver, a scanner driver, and a PC-FAX driver are shown as the device driver, and a device management software is shown as the application software. Some of the application software is dependent type application software that cannot fulfill their functions sufficiently unless any device driver is executed together. The device management application software for obtaining information of a peripheral device through a device driver and managing the peripheral device is given as an example of such the dependent type application software.

FIG. 3 delineates that the device drivers for the MFPs 20, 30, 40 have been installed in the PC 10. Since the installation status for the MFP 50 is not shown in the installation status memory 14b, it is found that the device driver for the MFP 50 is not been installed in the PC 10.

More specifically, according to the table of FIG. 3, the model name “ABC100”, the IP address “-”, the port name “USB001”, the printer driver “TRUE”, the scanner driver “TRUE”, the PC-FAX driver “FALSE”, and the device management software “FALSE” are stored in the installation status memory 14b with regard to the MTP 20.

Since the TIP address is not set, the MFP 20 is locally connected to the PC 10 via the USB cable 70. Further, the printer driver and the scanner driver are indicative of “true” and others are indicative of “false”. Accordingly, with regard to the MFP 20, the printer driver and the scanner driver have been installed.

With regard to the MFP 30, the model name, the IP address, and the port name are respectively indicative of “ABC 100”, “100.01”, and “BRN100”. Accordingly, the MFP 30 is network-connected to the PC 10 via the LAN cable 60. Further, among the device drivers and the application software shown in the table of FIG. 3, the scanner driver and the device management software are indicative of “false” and others are indicative of “true”. Accordingly, with regard to the MFP 30, the scanner driver and the device management software have not been installed.

With regard to the MFP 40, the model name, the IP address, and the port name are respectively indicative of “DEF200”, “200.02”, and “BRN200”.

Accordingly, the MFP 40 is network-connected to the PC 10 via the LAN cable 60. Further, all of the device drivers and the application software shown in the table of FIG. 3 are indicative of “true”. Accordingly, with regard to the MFP 40, the installation status memory 14b stores that all of the device drivers and the application software have been installed.

The installation status memory 14b is configured as described above, and therefore, the user can recognize the installation status of the device driver and the application software on a device-by-device basis by referring the data stored in the installation status memory 14b.

Referring back to FIG. 2, the MFP 20 includes a CPU 21, a ROM (read only memory) 22, a RAM (random access memory) 23, a flash memory 24, a USB interface (USB DT) 25a for connecting to the USB cable 70, an LAN interface (LAN I/F) 25b for connecting to the LAN cable 60, a printer 26 having a print function, a scanner 27 having a scanner function, a modem 28 having a facsimile function, and an LCD (liquid crystal display) 29. The CPU 21, the ROM 22, the RAM 23, the flash memory 24, the USB I/F 25a, the LAN I/F 25b, the printer 26, the scanner 27, the modem 28, and the LCD 29 are interconnected through a bus line B. Note that since the MFPs 30, 40 and 50 have structures the same as that of the MFP 20, explanations on the MFPs 30, 40 and 50 will be omitted.

Next, referring to FIG. 4, the installation process will be described. The installation process shown in FIG. 4 is a process for installing a device driver and an application software for a peripheral device connected to the PC 10. This process is executed by the CPU 11 in accordance with instructions of the installer stored in the PC 10. According to the present embodiment, this installation process starts when a CD storing the device drivers and the application softwares installable by the installer is read by the CD reading unit 18.

In the installation process, the CPU 11 firstly executes a target device detecting process for detecting a target device from the peripheral devices locally connected and network-connected to the PC 10 (S401).

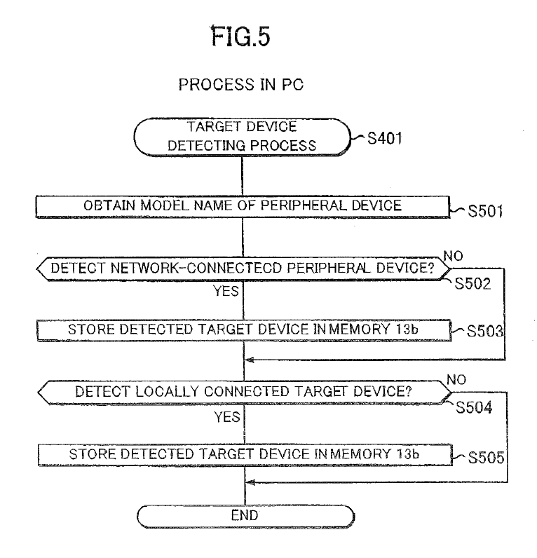

FIG. 5 is a flowchart illustrating steps in the target device detecting process. As shown in FIG. 5, the CPU 11 obtains, from the CD, a model name of the peripheral device for which the installer can install the device driver and the application software, and stores the model name in the model name memory 13a (S501).

Subsequently, the CPU 11 determines whether or not a peripheral device having a same model name as the model name stored in the model name memory 13a exists among the peripheral devices network-connected to the PC 10 (S502). For example, the CPU 11 requests, using broadcasting, the peripheral devices network-connected to the PC 10 (for example, the MFPs 30, 40, and 50) to send their model names and IP addresses, and determines whether or not the sent model name is identical with the model name stored in the model name memory 13a.

If the peripheral device having the same model name does not exist among the peripheral devices network-connected to the PC 10 (S502: NO), the CPU 11 advances to S504. If the peripheral device having the same model name exists among the peripheral devices network-connected to the PC 10 (S502: YES), the CPU determines the peripheral device having the same model name to be a target device and stores the IP address of the peripheral device having the same model name in the connected device memory 13b (S503). If a plurality of peripheral devices has the same model name; all of the peripheral devices having the same model name are determined to be the target devices and all of the IP addresses are stored in the connected device memory 13b.

Next, the CPU 11 determines whether or not a peripheral device having the same model name as the model name stored in the model name memory 13a exists among the peripheral devices locally connected to the PC 10 (S503). For example, the CPU 11 obtains, through the USB I/F 15b, the model names of the peripheral devices locally connected to the PC 10 and determines whether or not the obtained model name is identical with the model name stored in the model name memory 13a (S504).

If the peripheral device having the same model name does not exist among the peripheral devices locally connected to the PC 10 (S504: NO), the CPU 11 ends the process. If the peripheral device having the same model name exists among the peripheral devices locally connected to the PC 10 (S504: YES), the CPU 11 determines the peripheral device having the same model name to be the target device and stores the port name of the peripheral device having the same model name in the connected device memory 13b (S505). Then, the CPU 11 ends the process for detecting the target device. Hence, in the process for detecting the target device (S401), the CPU 11 detects the target device network-connected to the PC 10 as well as the target device locally connected to the PC 10, and stores the IP address and/or the port name of the detected target device in the connected device memory 13b.

After the process in S401 has been completed, as shown in FIG. 4, the CPU 11 selects one of the target devices detected in S401 (S402), and temporarily stores a connection mode (a connection I/F) of the selected target device with the PC 10 in the setting memory 13e (S403). That is, if the selected target device is network-connected to the PC 10, the “network” is stored in the setting memory 13c as the connection I/F of the selected target device. If the selected target device is locally connected to the PC 10, the “local” is stored in the setting memory 13c as the connection I/F of the selected target device. Subsequently, the CPU 11 investigates whether or not at least one device driver for the selected target device has been installed in the PC 10 in accordance with the connection I/F (S404, S405).

Specifically, if the selected target device is network-connected to the PC 10, the CPU 11 investigates whether or not a peripheral device having the same model name and the same IP address as those of the selected target device exists in the table of the installation status memory 14b. If such peripheral device exists in the installation status memory 14b, the CPU 11 determines that at least one device driver for the selected target device has been installed (S405: YES). If not, the CPU 11 determines that the device driver for the selected target device has not been installed (S405: NO).

On the other hand, if the selected target device is locally connected to the PC 10, the CPU 11 investigates whether or not a device having the same model name and the port name as those of the selected target device exists in the installation status memory 14b. If such peripheral device exists in the installation status memory 14b, the CPU 11 determines that at least one device driver for the selected target device has been installed (S405: YES). If riot, the CPU 11 determines that the device driver for the selected target device has not been installed (S405: NO).

As a result of the determination in S405, if the device driver for the selected target device has not been installed (S405: NO), the CPU 11 determines that the selected target device is subject to a new installation, and temporarily stores an installation type “new” in the setting memory 13c for the selected target device (S406).

If at least one device driver for the selected target device has been installed (S405: YES), the CPU 11 temporarily stores an installation type “installed” in the setting memory 13c for the selected target device (S407).

After temporarily storing the installation types in the setting memory 13c in S402 as described above, the CPU 11 determines whether or nor all of the target devices detected in S401 have been selected in S402 (S408). If all of the target devices detected in S401 have not been selected in S402 (S408: NO), the CPU 11 returns to S402. If all of the target devices detected in S401 have been selected in S402 (S408: YES), the CPU 11 completes storing the installation types on all of the target devices detected in S 401 in the setting memory 13c (S409).

Next, the CPU 11 determines whether the number of the target device whose installation type is “new” is only one, referring to the installation types stored in the setting memory 13c (S410). If the number of the target device whose installation type is “new” is only one (S410: YES), the CPU 11 executes a new installation process (described later) for automatically set the target device for which the device driver should be installed and the connection I/F of the target device (S411), and ends the installation process shown in FIG. 4. If the number of the target device whose installation type is “new” is not one (S410: NO), the CPU 11 advances to S412.

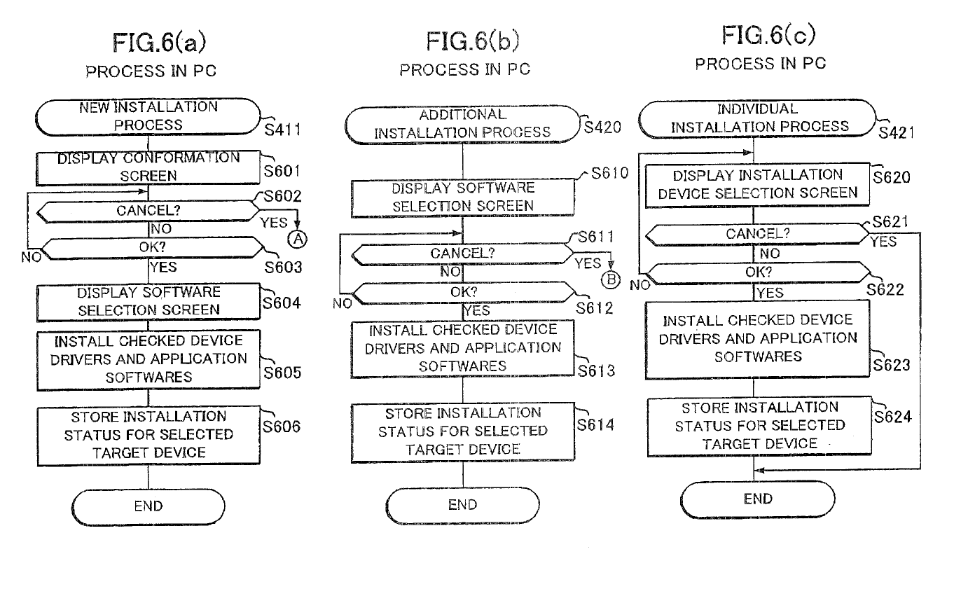

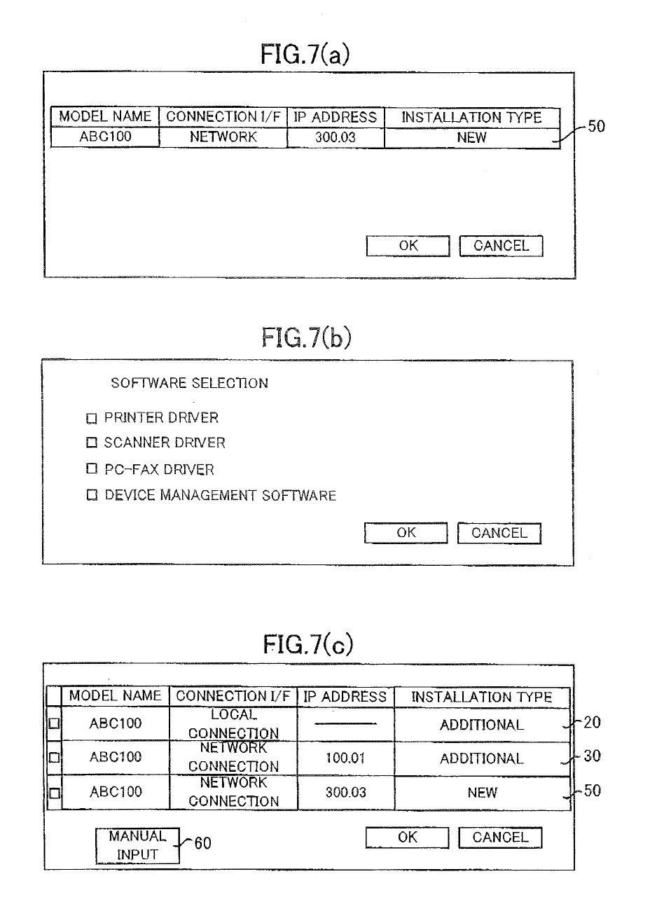

In the new installation process (S411), as shown in the flowchart of FIG. 6(a), the CPU 11 displays a confirmation screen on the display unit 17 to confirm that the device driver and the application software for the target device whose installation type is “new” should be installed (S601). The Confirmation screen displays the model name, the connection I/F, the IP address, and the installation type of the target device, as shown in FIG. 7(a). An OK button and a cancel button are also displayed in lower right part of the confirmation screen.

Referring back to FIG. 6(a), the CPU 11 determines whether or not the cancel button is pressed in the confirmation screen (S602). If the cancel button is pressed (S602: YES), the CPU 11 advances to S412 of FIG. 4. If the cancel button is not pressed (S602: NO), the CPU 11 determines whether or not the OK button is pressed (S603).

If the OK button is not pressed (S603: NO), the CPU 11 returns to S602. If the OK button is pressed (S603: YES), the CPU 11 displays a software selection screen on the display unit 17 for the user to select the device drivers and the application softwares to be installed (S604).

The software selection screen displays a list of all of the device drivers and the application softwares for the target device that is stored in the CD, as shown in FIG. 7(b). In addition, check boxes are displayed next to the respective device driver and application software. An OK button and a cancel button are displayed in a lower right part of the screen. The user can check the check boxes to select the desired device driver and/or application software to be installed via the keyboard 16. If at least one check box is checked and the OK button is pressed, the CPU 11 installs the checked device driver and/or application software.

In this case, the CPU 11 executes to install the checked device drivers and application softwares in accordance with the connection I/F (S605). More specifically, in case of the MFP 50, the CPU 11 executes the new installation process upon setting the connection I/F to the “network”, stores the installation status for the selected target device in the installations status memory 14b (S606), and ends the new installation process.

Referring back to FIG. 4; if the number of the target device whose installation type is “new” is zero or more than two (S410: NO), the CPU 11 selects one of the target devices detected in S401 (S412). In the same manner as S403 described above, the CPU 11 temporarily stores the connection I/F of the selected target device with the PC 10 in the setting memory 13c in S413. Subsequently, the CPU 11 investigates whether or not all of the device drivers and the application softwares for the selected target device have been installed (S414, S415).

Specifically, the CPU 11 investigates whether all of the device drivers and the application softwares shown in the installation status memory 14b for the selected target device (in the example of FIG. 7(b), the printer driver, the scanner driver, the PC-FAX driver, and the device management software) are indicative of “true”. If all of the device drivers and the application softwares shown in the installation status memory 14b are indicative of “true”, the CPU 11 determines that all of the device drivers and the application softwares for the selected target device have been installed (S415: YES).

If at least one of the device drivers and the application softwares shown in the installation status memory 14b are indicative of “false” (S415: NO), the CPU 11 determines that the device drivers and the application softwares for the selected target device have not been completely installed, that is, the selected target device is subject to an additional installation, and temporally stores the installation type “additional” in the setting memory 13c for the selected target device (S416).

After temporarily storing the installation type in the setting memory 13c in S412 as described above, the CPU 11 determines whether all of the target devices detected in S401 have been selected in S412 (S417). If all of the target devices detected in S401 have not been selected in S412 (S417: NO), the CPU 11 returns to S412, If all of the target devices detected in S401 have been selected in S412 (S417: YES), the CPU 11 completes storing the installation types on all of the target devices detected in S 401 in the setting memory 13c in the same manner as S409 described above (S418).

Next, the CPU 11 determines whether the number of the target device whose installation type is “additional” is only one and the number of the target device whose installation type is “new” is zero (S419). If the number of the target device whose installation type is “additional” is only one and the number of the target device whose installation type is “new” is zero (S419: YES), the CPU 11 executes an additional installation process (described later) for additionally installing the device drivers and the application softwares for the target device (S420), and ends the installation process.

If the number of the target device whose installation type is “additional” is zero or more than two or the number of the target device whose installation type is “new” is more than one (S419: NO), the CPU 11 executes an individual installation process for installing the desired device drivers and the application softwares in accordance with the user's instructions (S421), and ends the installation process.

In the additional installation process (S420), as shown in the flowchart of FIG. 6(b), the CPU 11 displays the software selection screen as shown in FIG. 7(b) on the display unit 17 for the user to select the device drivers and the application softwares to be installed for the target device whose installation type is “additional” (S610).

The CPU 11 determines whether or not the cancel button is pressed in the software selection screen (S611). If the cancel button is pressed (S611: YES), the CPU 11 advances to S421. If the cancel button is not pressed (S611: NO), the CPU 11 determines whether or not at least one check box is checked and the OK button is pressed (S612).

If either at least one check box is not checked or the OK button is not pressed (S612: NO), the CPU 11 returns to S611. If at least one check box is checked and the OK button is pressed (S612: YES), the CPU 11 installs the checked device driver and/or application software (S613). Then, the CPU 11 stores the installation status for the selected target device in the installation status memory 14b (S614), and ends the additional installation process.

In the Individual installation process (S421), as shown in the flowchart of FIG. 6(c), the CPU 11 displays, on the display unit 17, an installation device selection screen including a list of the target devices subject to the new installation and the additional application software installation (S620). As shown in FIG. 7(e), the installation device selection screen displays the list in which the check box, the model name, the connection VP, the IP address, and the installation type are provided for each target device. A manual input button is displayed in lower left part of the screen. An OK button and a cancel button are displayed in lower right part of the screen.

According to the above described example, the CPU 11 reads out the setting conditions on the MFPs 20, 30 and 50 stored in the setting memory 13c, and displays the setting conditions on the installation device selection screen as a list. More specifically, with regard to the MFP 20, the model name, the connection I/F, the IP address, and the installation type are respectively indicative of “ABC 100”, “local connection”, “N/A”, and “additional”. With regard to the MFP 30, the model name, the connection I/F, the IP address, and the installation type are respectively indicative of “ABC 100”, “network connection”, “100.01”, and “additional”. With regard to the MFP 50, the model name, the connection PP, the IP address, and the installation type are respectively indicative of “ABC 100”, “network connection”, “300.03”, and “new”. The peripheral devices that are subject to neither the new installation nor the additional application software installation are not displayed on the list in the installation device selection screen.

If the user selects at least one target device to install the device driver and/or the application software, checks the check box of the selected target device via the keyboard 16, and presses the OK button, the CPU 11 installs the checked device driver and/or the application software.

More specifically, if the MFP 20 is selected, the CPU 11 executes the additional installation process in S420 upon setting the connection VP to the “local”. If the MFP 30 is selected, the CPU 11 executes the additional installation process in S420 upon setting the connection I/F to the “network”. Thus, the additional installation process can be directly executed without executing the new installation process. If the I\UP 50 is selected, the CPU 11 executes the new installation process upon setting the connection I/F to the “network”.

Next, referring back to FIG. 6(c) again, the CPU 11 determines whether or not the cancel button is pressed in the installation device selection screen (S621). If the cancel button is pressed (S621: YES), the CPU 11 ends the individual installation process. If the cancel button is not pressed, (S621: NO), the CPU 11 determines whether or not at least one check box is checked and the OK button is pressed (S622).

If either at least one check box is not checked or the OK button is not pressed (S622: NO), the CPU 11 returns to S620. If at least one check box is checked and the OK button is pressed (S622: YES), the CPU 11 installs the checked device driver and the application software (S623). Then, the CPU 11 stores the installation status for the selected target device in the installation status memory 14b (S624), and ends the individual installation process.

If the manual input button is pressed in the installation device selection screen subsequent to checking the check box of the selected target device, the user can select or text-input the connection I/F, the IP address (the port name), and the device driver and the application software. Based on the user's selection or input, the CPU 11 executes installation of the device drivers and the application soft-wares.

In the installation process described above, if the number of the target device whose device driver has not been installed in accordance with the connection I/F is only one the CPU 11 can automatically set the target device for which the device driver should be installed and the connection I/F of the target device. In other words, the user needs to select neither the connection I/F nor the target device when installing the device driver. Therefore, the user can save time and effort for selecting the connection I/F and the target device.

Further, if the number of the target device for which all of the device driver and the application softwares have not been installed though at least one device driver has been installed is only one, the CPU 11 can automatically set the target device for which the device driver and/or the application software should be installed and the connection I/F of the target device. In other words, the user needs to select neither the connection I/F nor the target device in installing the device driver and/or the application software. Therefore, the user can save time and effort for selecting the connection I/F and the target device.

Further, the installation device selection screen for the individual installation process does not include the target devices for which all of the device drivers and the application softwares have been already installed. Accordingly, the user can simply select the target device necessary for installing the device driver and/or the application software among the listed target devices.

Next, a second embodiment of the installation process described in the flowchart of FIG. 4 will be described while referring to FIG. 8. The installation process according to the second embodiment, in the same manner as the first embodiment, installs the device drivers and the application softwares for the peripheral device connected to the PC 10. The CPU 11 executes the installation process in accordance with the instructions of the installer stored in the PC 10.

In the installation process according to the second embodiment, when the CD storing the device drivers and the application softwares installable by the installer is read by the CD reading unit 18, the CPU 11 obtains, from the CD, the model name the peripheral device for which the installer can install the device drivers and the application softwares, and stores the model name in the model name memory 13a (S701).

Then, the CPU 11 investigates whether or not the device driver for the target device having the same model name as the model name stored in the model name memory 13a exists in the installation status memory 14b in the connection TIP “local” (S702, S703).

If such target device exists (S703: YES), the CPU 11 determines that at least one device driver for the target device has been installed in the connection I/F “local”, and investigates, referring to the installation status memory 14b in the same manner as described in the first embodiment, whether all of the device drivers and the application softwares for the target device have been installed, that is, whether all of the device drivers and the application softwares are indicative of “true” in the installation status memory 14b (S704, S705).

As a result of determination in S705, if all of the device drivers and the application softwares have been installed (S705: YES), no device driver and application software needs to be additionally installed in the connection I/F “local”. In other words, it is found that the user attempts to install the device driver and/or the application software not in the connection I/F “local” but in the connection I/F “network”. Accordingly, the CPU 11 sets the connection I/F to the “network” (S706). Subsequently, the CPU 11 executes the new installation process to install the device driver for the target device (S707), stores the installation status for the selected target device in the installation status memory 14b (S708), and ends the new installation process.

As described above, if all of the device drivers and the application softwares for the target device has been installed in the connection I/F “local” (S703, S705: YES), the CPU 11 automatically sets the connection. I/F to the “network” to execute the new installation process (S707). Therefore, the user needs not to select or to confirm the connection I/F in S706, and can save time and effort for selecting the connection I/F.

As a result of the determination in S705, if all of the device drivers and the application softwares for the target device have not been installed (S705: NO), the user may attempt to install the non-installed device driver and/or application software.

Accordingly, the CPU 11 then tentatively sets the connection OF to “local” (S709) displays a confirmation screen on the display unit 17 to confirm the user whether or not the setting of the connection I/F to “local” is correct, and determines whether or not the user presses an OK button (S710). If the OK button is pressed (S710: YES), the CPU 11 displays the software selection screen as shown in FIG. 7(b) on the display unit 17 (S711), in the same manner as FIG. 6(b) according to the first embodiment.

The CPU 11 determines whether or not the user selects the desired device driver and/or application software and presses the OK button (S712). If the user neither selects the desired device driver and/or application software nor presses the OK button (S712: NO), the CPU 11 returns to S711. If the user selects the desired device driver and/or application software and presses the OK button (S712: YES), the CPU 11 installs the selected device driver and/or application software (S713). The CPU 11 stores the installation status for the selected target device in the installation status memory 14b (S708), and ends the installation process.

As described above, when the user attempts to install only the device drivers and/or application softwares in the connection I/F “local”, execution of the new installation process can be avoided. Accordingly, the user can save time.

Further, if the device driver for the target device has not been installed in the connection IN “local” (S703: NO), or if the user does not intend to install the device driver and/or application software in the connection TIP “local” (S710: NO), the CPU 11 displays a connection interface selection screen (not shown) on the display unit 17 (S714). In other words, the CPU 11 confirms the user whether the connection I/F for the target device should be set to the “network” or the “local”.

Then, the CPU 11 determines whether either the “network” or the “local” is selected and an OK button in the connection interface selection screen is pressed (S715). If the OK button is not pressed (S715: NO), the CPU 11 returns to S714. If OK button is pressed (S715: YES), the CPU 11 executes the new installation process in the selected connection I/F (S716). The CPU 11 stores the installation status for the target device in the installation status memory 14b (S708), and ends the new installation process.

As described above, according to the installation process of the second embodiment, if all of the device drivers and the application softwares for the target device have been installed in the connection OF “local”, the user attempts to install the device driver and the application software in the connection I/F “network”. Therefore, the user needs not to set the connection DT to the “network”, and can save time and effort for selecting the connection I/F.

Further, according to the first embodiment, if the target device is switched off, the CPU 11 cannot detect whether or not the target device is connected to the PC 10 in S401. However, according to the second embodiment, regardless of whether or not the target device is connected to the PC 10, the CPU 11 detects the target device according to the installation status stored in the installation status memory 14b. Accordingly, the CPU 11 can detect the target device regardless of whether the target device is switched on or off.

While the invention has been described in detail with reference to the embodiments thereof, it would be apparent to those skilled in the art that various changes and modifications may be made therein without departing from the spirit of the invention.

According to the first embodiment, the CPU 11 displays, on the software selection screen, the device drivers and application softwares that have not been installed, in the additional installation process as shown in FIG. 7(b). However, if there is a device driver or application software that has been installed, the installed device driver or application software may be also displayed on the software selection screen. If the installed device driver and application software are displayed on the software selection screen, it is preferable to indicate that the device driver and the application software have been installed.

Further, if the number of the device driver or the application software which has not been installed for the selected target device is only one, the user would attempt to install the non-installed application software. In this case, the CPU 11 may automatically install the non-installed application software without displaying the application software selection screen on the display unit 17.

According to the first embodiment, the CPU 11 investigates in S404 whether or not the device driver for the target device has been installed, regardless of whether the target device is locally connected or is network-connected to the PC 10. However, for example, if the target device is locally connected to the PC 10, all of the device drivers and the application softwares for the target device have not been installed though at least one device driver has been installed, and the target device that is network-connected to the PC does not exist, the CPU 11 may automatically set the connection I/F to the “local” to install the device drivers and the application softwares in the connection I/F “local”.

According to the first embodiment, the PC 10 connects to the plurality of MPFs via the USB or network connection. However, for example, the PC 10 can connect to the single MFP via the USB or network connection. If the CPU 11 determines that the installation type of the single MFP is “new”, the CPU 11 automatically executes the new installation process in S411, whereas if CPU determines that the installation type of the single MFP is “additional”, the CPU 11 automatically executes the additional installation process in S420.

According to the second embodiment, the CPU 11 investigates in S702 whether or not the device driver for the target device has been installed in the connection I/F “local”. However, the CPU 11 may investigate whether or not the number of the target device for which the device driver has been installed in the connection I/F “network” is only one. If the number is only one and all of the device drivers and the application softwares for the target device has been installed in S704, the CPU 11 may set the connection PP to the “local” in S706 to execute the new installation process.

According to the second embodiment, the CPU 11 investigates whether or not the device driver for the target device having the same model name as the model name stored in the model name memory 13a exists in the installation status memory 14b in the connection I/F “local”. However, the CPU 11 can investigate whether or not the device driver for the target device having the same model name as the model name stored in the model name, memory 13a exists in the installation status memory 14b in the connection I/F “network”. In this configuration, the CPU 11 sets the connection I/F to the “local” in S706 and sets the connection I/F to the “network” in S709.

What is claimed is:

1. A computer readable storage medium storing a computer-executable installation program for installing, on an information processing device which is connectable with a peripheral device in a plurality of connection modes, a software including at least one device driver for the peripheral device upon setting installation mode to each connection mode, the installation program comprising:
instructions (a) for detecting the peripheral device connected with the information processing device;
instructions (b) for detecting the connection mode of the detected peripheral device;
instructions (c) for determining whether or not at least one device driver for the detected peripheral device has been installed on the information processing device in accordance with the detected connection mode; and
instructions (d) for automatically setting the installation mode to the detected connection mode to install the device driver in accordance with the detected connection mode if at least one device driver for the detected peripheral device has not been installed on the information processing device in accordance with the detected connection mode.

2. The computer readable storage medium according to claim 1, wherein the information processing device includes a displaying unit, and
wherein the program further comprises instructions (e) for displaying, on the displaying unit, a selection screen for selecting the device driver for the peripheral device detected in instructions (a).

3. A computer readable storage medium storing a computer-executable installation program for installing, on an information processing device which is connectable with a peripheral device in a plurality of connection modes, a software including at least one device driver for the peripheral device upon setting installation mode to each connection mode, the installation program comprising:
instructions (a) for detecting a plurality of peripheral devices connected with the information processing device;
instructions (b) for detecting the connection mode of each peripheral device detected in instructions (a);
instructions (c) for detecting the number of the peripheral device detected in instructions (a) for which at least one device driver has been installed on the information processing device in accordance with the detected connection mode;
instructions (d) for automatically setting the installation mode to the detected connection mode to install the device driver in accordance with the detected connection mode, if the number detected in instructions (c) is one.

4. The computer readable storage medium according to claim 3, wherein if it is detected in instructions (c) that at least one device driver has been installed on the information processing device in accordance with the detected connection mode for all of the peripheral devices detected in instructions (a), and that the number of the peripheral device for which all of the device drivers have not been installed on the information processing device in accordance with the detected connection mode is one, instructions (d) automatically setting the installation mode to the detected connection mode to install the device driver detected in instructions (c) in accordance with the detected connection mode.

5. The computer readable storage medium according to claim 3, wherein the information processing device includes a displaying unit, and
wherein the program further comprises instructions (e) for displaying, on the displaying unit, a first selection screen for selecting the peripheral device detected in instructions (c) to install the device driver, if the number detected in instructions (c) is not one.

6. The computer readable storage medium according to claim 5, wherein the program further comprises instructions (f) for displaying, on the displaying unit, a second selection screen for selecting the device driver for the peripheral device selected in instructions (e), if the number detected in instructions (c) is one.

7. A computer readable storage medium storing a computer-executable installation program for installing, on an information processing device which is connectable with a peripheral device in a plurality of connection modes, a software including at least one device driver for the peripheral device upon setting installation mode to each connection mode, the installation program comprising:
instructions (a) for detecting the peripheral device connected with the information processing device;
instructions (b) for detecting the connection mode of the detected peripheral device;
instructions (c) for determining whether or not all of the device drivers for the detected peripheral device have been installed on the information processing device in accordance with a predetermined connection mode; and
instructions (d) for automatically setting the installation mode to a connection mode different from the detected connection mode to install the device driver in accordance with the detected connection mode if all of the device drivers for the detected peripheral device have been installed on the information processing device in accordance with the predetermined connection mode.

8. The computer readable storage medium according to claim 7, wherein if all of the device drivers for the detected peripheral device have been installed on the information processing device in accordance with one of a local connection mode and a network connection mode, in instructions (d) for automatically setting the installation mode to the connection mode that is not set currently.

9. An information processing device, which is connectable with a peripheral device in a plurality of connection modes, for installing a software including at least one device driver for the peripheral device thereon upon setting installation mode to each connection mode, the information processing device comprising:
a first detecting unit that detects the peripheral device connected with the information processing device;
a second detecting unit that detects the connection mode of the detected peripheral device;
a determining unit that determines whether or not at least one device driver for the detected peripheral device has been installed on the information processing device in accordance with the detected connection mode; and
a setting unit that automatically sets the installation mode to the detected connection mode to install the device driver in accordance with the detected connection mode if at least one device driver for the detected peripheral device has not been installed on the information processing device in accordance with the detected connection mode.

10. An information processing device, which is connectable with a peripheral device in a plurality of connection modes, for installing a software including at least one device driver for the peripheral device thereon upon setting installation mode to each connection mode, the installation device comprising:
a first detecting unit that detects a plurality of peripheral devices connected with the information processing device;
a second detecting unit that detects the connection mode of each peripheral device detected in the first detecting unit;
a third detecting unit that detects the number of the peripheral device detected in the first detecting unit for which at least one device driver has been installed on the information processing device in accordance with the detected connection mode;
a setting unit that automatically sets the installation mode to the detected connection mode to install the device driver in accordance with the detected connection mode, if the number detected in the third detecting unit is one.

11. An information processing device, which is connectable with a peripheral device in a plurality of connection modes, for installing a software including at least one device driver for the peripheral device thereon upon setting installation mode to each connection mode, the information processing device comprising:
a first detecting unit that detects the peripheral device connected with the information processing device;
a second detecting unit that detects the connection mode of the detected peripheral device;
a determining unit that determines whether or not all of the device drivers for the detected peripheral device have been installed on the information processing device in accordance with a predetermined connection mode; and
a setting unit that automatically sets the installation mode to a connection mode different from the detected connection mode to install the device driver in accordance with the detected connection mode if all of the device drivers for the detected peripheral device have been installed on the information processing device in accordance with the predetermined connection mode.
